(19) United States
(12) Patent Application Publication
(10) Pub. No.: US 2024/0098847 A1
(43) Pub. Date: Mar. 21, 2024

(54) HEATER

(71) Applicant: Sumitomo Electric Industries, Ltd., Osaka-shi, Osaka (JP)

(72) Inventors: Koichi KIMURA, Osaka-shi, Osaka (JP); Ryohei FUJIMI, Osaka-shi, Osaka (JP); Katsuhiro ITAKURA, Osaka-shi, Osaka (JP)

(73) Assignee: Sumitomo Electric Industries, Ltd., Osaka-shi, Osaka (JP)

(21) Appl. No.: 18/273,778

(22) PCT Filed: Jan. 26, 2021
(86) PCT No.: PCT/JP2021/002618

§ 371 Date: Jul. 24, 2023

(51) Int. Cl. H05B 3/02; H05B 3/22

(52) U.S. Cl. CPC H05B 3/02; H05B 3/22; H05B 3/0004

(57) ABSTRACT

A heater includes a base, a plurality of heating bodies, a plurality of terminals, and a cylindrical. The base has a first surface on which a heating target is placed, and a second surface opposite to the first surface. The plurality of heating bodies include an inside heating body disposed in a region including a center of the base, and a plurality of outside heating bodies disposed outside of the inside heating body to be concentric with the base. The inside heating body and the plurality of outside heating bodies are disposed to be spaced from each other in a thickness direction of the base. The inside heating body is disposed at a first layer located closest to the first surface in the thickness direction of the base. The plurality of outside heating bodies include a first outside heating body, and a second outside heating body.

### TECHNICAL FIELD

The present disclosure relates to a heater.

### BACKGROUND

PTL 1 discloses a heater including a mounting table, a plurality of heating circuits, a plurality of terminal portions, and a cylindrical support member. A mounting surface of the mounting table on which the object to be heated is placed is divided into two or more zones. The plurality of heating circuits are embedded in the mounting table for each zone. The plurality of heating circuits are embedded in layers at different positions in the thickness direction of the mounting table. The plurality of terminal portions are electrically connected to end portions of the heating circuit. The tubular support member accommodates a plurality of terminal portions therein.

### PRIOR ART DOCUMENT

### Patent Literature

PTL 1: Japanese Unexamined Patent Application Publication No 2017-174713

### SUMMARY

A heater of the present disclosure includes a disk-shaped base, a plurality of heating bodies disposed in the base, a plurality of terminals each connected to a corresponding one of the plurality of heating bodies, and a cylindrical member attached to the base. The base has a first surface on which a heating target is placed, and a second surface opposite to the first surface. The plurality of heating bodies include an inside heating body disposed in a region including a center of the base, and a plurality of outside heating bodies disposed outside of the inside heating body to be concentric with the base. The inside heating body and the plurality of outside heating bodies are disposed to be spaced from each other in a thickness direction of the base. The inside heating body is disposed at a first layer located closest to the first surface in the thickness direction of the base. The plurality of outside heating bodies include a first outside heating body disposed at a second layer adjacent to the first layer in the thickness direction of the base, and a second outside heating body disposed at a third layer located closer than the second layer to the second surface in the thickness direction of the base. The plurality of terminals include a first terminal, a second terminal, and a third terminal concentrically disposed in order from a center side of the base. The first terminal is connected to the inside heating body. The second terminal is connected to the second outside heating body. The cylindrical member is attached to the second surface to surround the plurality of terminals in a plan view of the heater from the first surface.

### BRIEF DESCRIPTION OF THE DRAWINGS

FIG. 1 is an explanatory view showing an outline of a heater of an embodiment.

FIG. 2 is an explanatory view showing a positional relationship between a plurality of heating bodies in the heater of the embodiment.

FIG. 3 is an e explanatory view showing a positional relationship between a plurality of terminals in the heater of the embodiment.

FIG. 4 is an explanatory view showing a positional relationship between a heating body and a terminal in the heater of the embodiment.

FIG. 5 is an explanatory view showing an example of a circuit pattern of the inside heating body in the heater of the embodiment.

FIG. 6 is an explanatory view showing another example of the circuit pattern of the inside heating body in the heater of the embodiment.

FIG. 7 is an explanatory view showing a positional relationship between a heating body and a terminal in a heater of a comparative example.

FIG. 8 is an explanatory view showing an example of a circuit of the inside heating body in the heater of the comparative example.

FIG. 9 is an explanatory view showing a positional relationship between a plurality of heating bodies in a heater of modification 1.

FIG. 10 is an explanatory view showing the positional relationship of a plurality of terminals in a heater of modification 1.

FIG. 11 is an explanatory view showing a positional relationship between a plurality of heating bodies in the heater of modification 2.

FIG. 12 is an explanatory view showing a positional relationship of a plurality of terminals in a heater of modification 2.

FIG. 13 is an explanatory view showing a positional relationship between a heating body and a terminal in a heater of modification 3.

### DETAILED DESCRIPTION

### Problems to be Solved by Present Disclosure

In a heater provided with a plurality of heating bodies, both end portions of each heating body are collected at a predetermined position on the center side of the base, and each terminal is connected to the predetermined position in many cases. This is because a cylindrical member accommodating a terminal and a lead-out line connected to the terminal is connected to the center side of the base. In the heater provided with the plurality of heating bodies, the plurality of terminals are densely disposed on the center side of the base. When a plurality of terminals are densely disposed, each terminal is likely to interfere with the inside heating body disposed on the center side of the base. For example, when the interlayer distance between the layer on which the inside heating body is disposed and the layer on which the outside heating body is disposed is small, the terminal connected to the outside heating body may contact the inside heating body. In addition, when the inside heating body and the terminal connected to the outside heating body are close to each other, the heat of the inside heating body may be dissipated to the outside through the terminal connected to the outside heating body.

In order to suppress the interference, it is conceivable to dispose the inside heating body so as to avoid terminals that may interfere with the inside heating body among the terminals connected to the outside heating body. In this case, a space for disposing the inside heating body is not sufficiently secured on the center side of the base, and there is a concern that a temperature decrease may occur on the center side of the base.

An object of the present disclosure is to provide a heater capable of suppressing a temperature decrease on the center side of a base.

### Advantageous Effects of Present Disclosure

The heater of the present disclosure can suppress the temperature decrease on the center side of the base.

### DESCRIPTION OF EMBODIMENTS OF PRESENT DISCLOSURE

First, embodiments of the present disclosure will be listed and explained.

(1) A heater according to an aspect of present disclosure includes a disk-shaped base, a plurality of heating bodies disposed in the base, a plurality of terminals each connected to a corresponding one of the plurality of heating bodies, and a cylindrical member attached to the base. The base has a first surface on which a heating target is placed, and a second surface opposite to the first surface. The plurality of heating bodies include an inside heating body disposed in a region including a center of the base, and a plurality of outside heating bodies disposed outside of the inside heating body to be concentric with the base. The inside heating body and the plurality of outside heating bodies are disposed to be spaced from each other in a thickness direction of the base. The inside heating body is disposed at a first layer located closest to the first surface in the thickness direction of the base. The plurality of outside heating bodies include a first outside heating body disposed at a second layer adjacent to the first layer in the thickness direction of the base, and a second outside heating body disposed at a third layer located closer than the second layer to the second surface in the thickness direction of the base. The plurality of terminals include a first terminal, a second terminal, and a third terminal concentrically disposed in order from a center side of the base. The first terminal is connected to the inside heating body. The second terminal is connected to the second outside heating body. The cylindrical member is attached to the second surface to surround the plurality of terminals in a plan view of the heater from the first surface.

The heater of the present disclosure can prevent the second terminal and the third terminal from interfering with the inside heating body even when a plurality of terminals are densely disposed on the center side of the base. This is because the plurality of terminals are disposed concentrically in order from the center side, and the second terminal is connected to the second outside heating body. Since the second terminal is a terminal connected to the second outside heating body, the distance between the inside heating body and the second terminal can be increased as compared with the case where the second terminal is a terminal connected to the first outside heating body. This is because the third layer on which the second outside heating body is disposed is located farther from the first layer than the second layer on which the first outside heating body is disposed. Since the distance is large, it is possible to prevent the second terminal from interfering with the inside heating body. Since the second terminal does not interfere with the inside heating body, the inside heating body can be disposed at a desired position without considering the position of the second terminal. The third terminal is located farther from the center than the second terminal. Therefore, it is possible to secure a wide arrangement space in the circumferential direction in the third terminal, and it is easy to dispose the third terminal so as not to overlap the inside heating body in the plan view of the heater from the first surface. Therefore, it is possible to prevent the position of the inside heating body from being limited due to the position of the third terminal. Since it is possible to prevent the second terminal and the third terminal from interfering with the inside heating body, it is possible to sufficiently dispose the inside heating body on the center side of the base. As described above, the heater of the present disclosure can suppress the temperature decrease on the center side of the base.

Here, the terminal interfering with the heating body means that the terminal cannot be disposed at a desired position of the heating body due to a mechanical factor, an electrical factor, or a manufacturing reason. The mechanical factor is contact between the terminal and the heating body. The electrical factor is that the distance between the terminal and the heating body is reduced and thus electrical insulation cannot be ensured. As the manufacturing reason, it is not possible to provide a working space for arranging the constituent members of the heater at desired positions.

(2) In one example of the heater of present disclosure, in the plan view of the heater from the first surface, an outer peripheral contour line of the inside heating body is located outside of an inscribed circle centered at the center of the base and formed by the third terminal.

In the above configuration, the second terminal and the third terminal are likely to interfere with the inside heating body. As described above, the heater of the present disclosure can prevent the second terminal and the third terminal from interfering with the inside heating body. Therefore, the heater of the present disclosure can suppress the temperature decrease on the center side of the base even in the above-described embodiment.

(3) In an example of the heater of present disclosure, in the plan view of the heater from the first surface, an outer peripheral contour line of the inside heating body is located outside of an inner peripheral contour line of the cylindrical member.

In the above configuration, the second terminal and the third terminal are more likely to interfere with the inside heating body. As described above, the heater of the present disclosure can prevent the second terminal and the third terminal from interfering with the inside heating body. Therefore, the heater of the present disclosure can suppress the temperature decrease on the center side of the base even in the above-described embodiment.

(4) In an example of the heater of the present disclosure, at least one of the plurality of outside heating bodies is formed by a plurality of heating body segments divided in a circumferential direction.

Since the plurality of outside heating bodies are disposed outside of the inside heating body to be concentric with the base, the temperatures of the plurality of heating bodies can be independently controlled in the radial direction of the base. In the above-described embodiment, since each outside heating body is composed of a plurality of heating body segments, the temperature of each outside heating body can be independently controlled in the circumferential direction in addition to the temperature control in the radial direction of the base. Therefore, in the above-described embodiment, it is easy to uniformly heat the entire surface of the heating target.

(5) In an example of the heater of the present disclosure, the second terminal includes a tip portion protruding from a surface of the second outside heating body closer to the first surface toward the first surface. A length of the tip portion in a protruding direction of the tip portion is smaller than an interlayer distance. The interlayer distance is a length between the surface of the second outside heating body closer to the first surface and a surface of the inside heating body closer to the second surface.

According to the aspect described above, even if the second terminal includes the tip portion, it is possible to prevent the second terminal from interfering with the inside heating body.

(6) In an example of the heater of (5), the interlayer distance is 1 mm to 15 mm.

When the interlayer distance is 1 mm or more, it is easy to secure the distance between the heating bodies adjacent to each other in the thickness direction of the base, and it is easy to configure the heating body in the base. When the interlayer distance is 15 mm or less, it is possible to suppress an increase in the thicknesses of the bases including the thicknesses of each heating bodies. When the interlayer distance is 15 mm or less, it is possible to suppress an increase in the distance between the second outside heating body and the inside heating body, and thus it is easy to perform temperature control of the first surface. Even when the interlayer distance is 15 mm or less, the heater of the present disclosure can prevent the second terminal from interfering with the inside heating body.

(7) In an example of the heater of the present disclosure, each of the plurality of heating bodies is a foil-shaped body. An average thickness of each of the plurality of heating bodies is 1 μm to 500 μm.

Since each heating body is a foil-shaped body, it is possible to reduce variation in the distance from the surface near the first surface to the first surface in each heating body, and it is easy to uniformly heat the first surface. When the average thickness of each heating body is 1 μm or more, it is easy to configure the heating body in the base. When the average thickness of each heating body is 500 μm or less, it is easy to satisfactorily heat the heating target. When the average thickness of each heating body is 500 μm or less, a terminal to be connected easily penetrates the heating body. For example, as described above, the second terminal includes a tip portion protruding from the second outside heating body. Even in this case, the heater of the present disclosure can prevent the second terminal from interfering with the inside heating body.

(8) A heater according to an aspect of present disclosure includes a disk-shaped base, a plurality of heating bodies disposed in the base, a plurality of terminals each connected to a corresponding one of the plurality of heating bodies, and a cylindrical member attached to the base. The base has a first surface on which a heating target is placed, and a second surface opposite to the first surface. The plurality of heating bodies include an inside heating body disposed in a region including a center of the base, an outside heating body disposed outside of the inside heating body to be concentric with the base, and an intermediate heating body disposed between the inside heating body and the outside heating body. The inside heating body, the outside heating body, and the intermediate heating body are disposed to be spaced from each other in a thickness direction of the base. The inside heating body is disposed at a first layer located closest to the first surface in the thickness direction of the base. The outside heating body is disposed at a third layer located closest to the second surface in the thickness direction of the base. The intermediate heating body is disposed at a second layer located between the first layer and the third layer. The plurality of terminals include a first terminal, a second terminal, and a third terminal disposed concentrically in order from a center side of the base. The first terminal is connected to the inside heating body. The second terminal is connected to the outside heating body. The third terminal is connected to the intermediate heating body.

The cylindrical member is attached to the second surface to surround the plurality of terminals in the plan view of the heater from the first surface.

The heater of the present disclosure can prevent the second terminal and the third terminal from interfering with the inside heating body even when a plurality of terminals are densely disposed on the center side of the base, similarly to the heater of (1). In the heater of the present disclosure, the inside heating body can be disposed at a desired position without considering the positions of the second terminal and the third terminal. Specifically, the inside heating body can be sufficiently disposed on the center side of the base. Therefore, the heater of the present disclosure can suppress the temperature decrease on the center side of the base.

### Details of Embodiments of Present Disclosure

Embodiments of the heater of the present disclosure will now be described with reference to the drawings. The same reference numerals in the figures denote the same components.

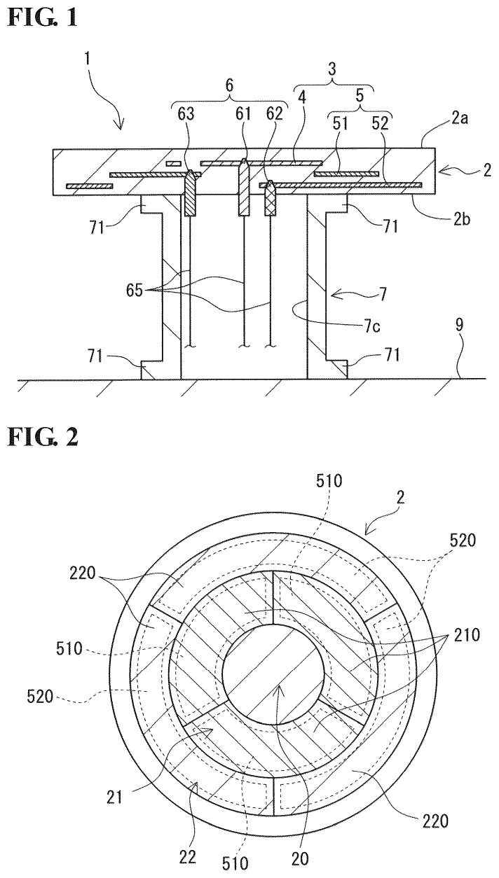

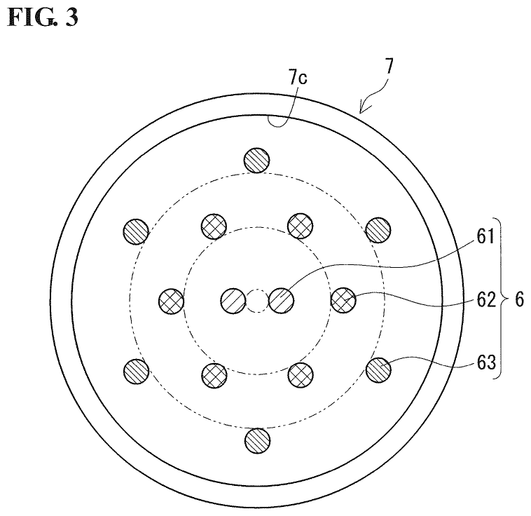

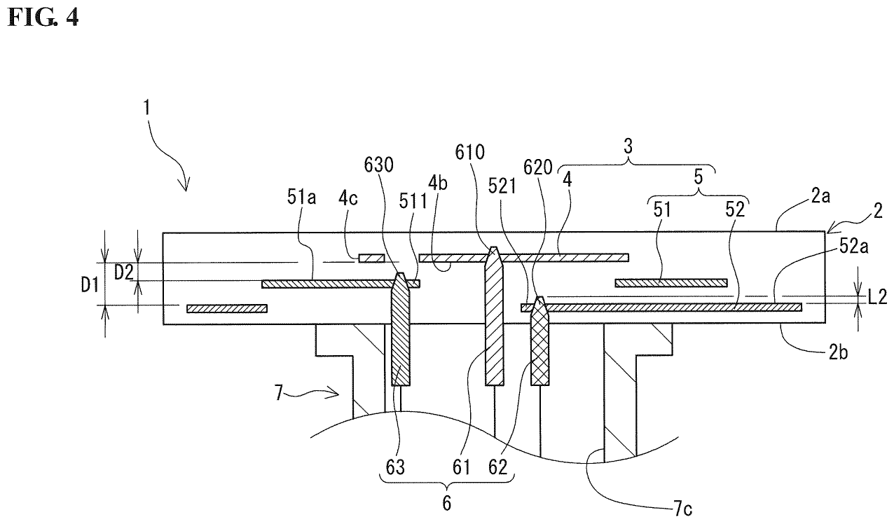

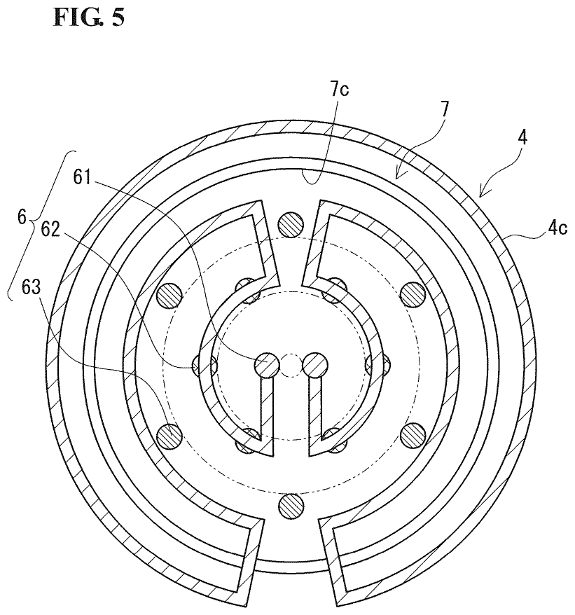

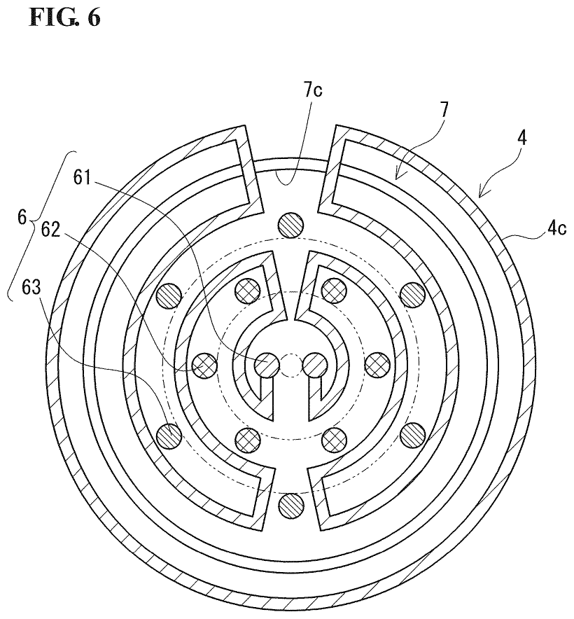

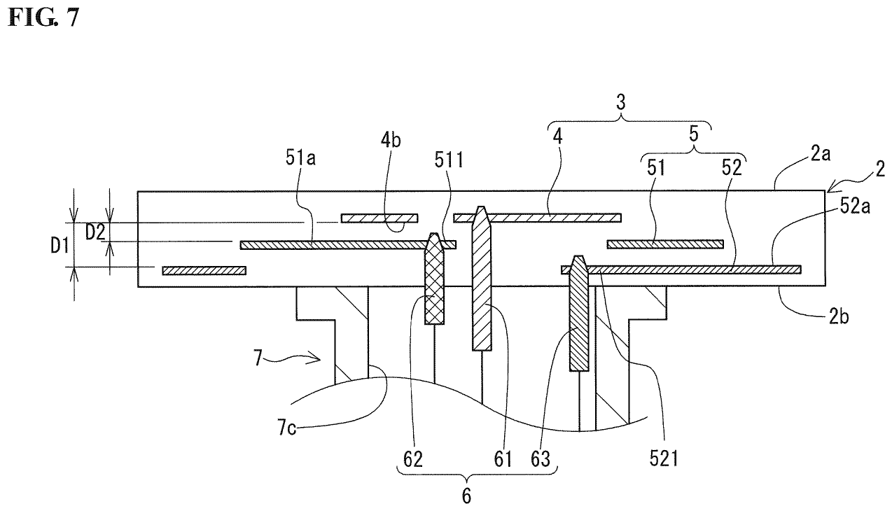

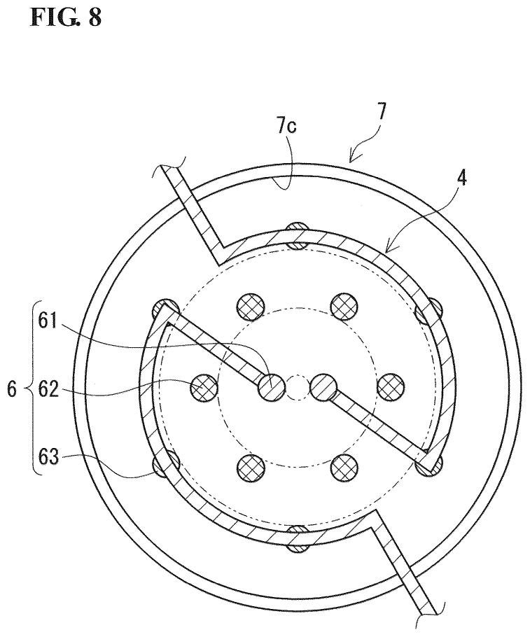

Referring to FIGS. 1 to 6, a heater 1 according to an embodiment will be described. Heater 1 includes a base 2, a plurality of heating bodies 3, a plurality of terminals 6, and a cylindrical member 7. Base 2 includes a first surface 2a on which a heating target (not shown) is placed and a second surface 2b opposite to first surface 2a. In the following description, the first surface 2a side of base 2 may be referred to as “upper”, and the second surface 2b side may be referred to as “lower”. FIG. 1 is a schematic view showing a positional relationship between the plurality of heating bodies 3 and the plurality of terminals 6 in a virtual cross section. Therefore, the shape and position of each heating body 3 and the number of each terminal 6 shown in FIG. 1 do not necessarily match the shape and position of each heating body 3 and the number of each terminal 6 shown in FIGS. 5 and 6. This also applies to the relationship between the shape and position of each heating body 3 and the number of terminals 6 shown in FIG. 7 and the relationship between the shape and position of each heating body 3 and the number of terminals 6 shown in FIG. 8. FIG. 2 is a view of base 2 viewed from first surface 2a. In FIG. 2, for convenience of explanation, a rough arrangement region of the plurality of heating bodies 3 is divided into three types of hatching. FIG. 3 is a view showing the positional relationship between cylindrical member 7 and the plurality of terminals 6 in the plan view of heater 1 from first surface 2a. In FIG. 3, the plurality of terminals 6 are shown separately by three types of hatching. In FIG. 3, each of the inscribed circle formed by a first terminal 61, the inscribed circle formed by a second terminal 62, and the inscribed circle formed by a third terminal 63 is indicated by a two dot chain line. FIG. 4 is an explanatory view showing the positional relationship of the constituent members of heater 1 as in FIG. 1. FIGS. 5 and 6 show the positional relationship among cylindrical member 7, an inside heating body 4, and the plurality of terminals 6 in a plan view of heater 1 from first surface 2a. In FIGS. 5 and 6, inside heating body 4 is hatched for ease of understanding. Only the circuit pattern of inside heating body 4 is different between FIG. 5 and FIG. 6. In the figures, heating bodies 3 and terminals 6 are shown in an exaggerated manner for clarity. In each drawing, the thickness of base 2, the thickness of each heating body 3, and the like are schematically shown and do not necessarily correspond to the actual thickness. The thickness of base 2 and the thickness of each heating body 3 are the length along the vertical direction in each drawing.

### <Overall Configuration>

As shown in FIGS. 1 and 4, the plurality of heating bodies 3 are disposed in base 2. The plurality of heating bodies 3 include inside heating body 4 and a plurality of outside heating bodies 5. Inside heating body 4 is disposed in a region including the center of base 2, i.e., an inside region 20 shown in FIG. 2. Inside region 20 is a circular region centered at the center of base 2. Inside region 20 is a circular region having a diameter of 80% or less of the diameter of base 2. The plurality of outside heating bodies 5 are disposed outside of inside heating body 4 to be concentric with base 2. The plurality of outside heating bodies 5 include a first outside heating body 51 and a second outside heating body 52. The plurality of outside heating bodies 5 are disposed outside of inside heating body 4 and in a plurality of annular regions concentric with the center of base 2. The annular regions are a first outside region 21 and a second outside region 22 shown in FIG. 2. Second outside region 22 is located outside of first outside region 21. Inside heating body 4 and the plurality of outside heating bodies 5 are disposed to be spaced from each other in the thickness direction of base 2. As shown in FIGS. 1 and 4, the plurality of terminals 6 are connected to each of the plurality of heating bodies 3. Cylindrical member 7 is attached to base 2 as shown in FIG. 1.

As shown in FIG. 4, one of the features of heater 1 of the embodiment is that inside heating body 4 is disposed at the first layer in base 2. The first layer is a layer located closest to first surface 2a in the thickness direction of base 2 among the layers in which heating bodies 3 are disposed in base 2. Another feature of heater 1 of the embodiment is that, as shown in FIG. 4, the plurality of terminals 6 include first terminal 61, second terminal 62 and third terminal 63 concentrically disposed in order from the center side of base 2, and first terminal 61 is connected to inside heating body 4 and second terminal 62 is connected to second outside heating body 52. First outside heating body 51 is a heating body disposed at the second layer adjacent to the first layer in the thickness direction of base 2 among the plurality of outside heating bodies 5. Second outside heating body 52 is a heating body disposed at the third layer located closer than second layer to second surface 2b in the thickness direction of base 2 among the plurality of outside heating bodies 5. Hereinafter, each configuration of base 2, cylindrical member 7, heating body 3, and terminal 6 will be described in detail.

### <Base>

Base 2 is a circular plate. Base 2 includes first surface 2a and second surface 2b. First surface 2a and second surface 2b face each other. A heating target (not shown) is placed on first surface 2a. The heating target is, for example, a wafer such as a semiconductor. Cylindrical member 7 to be described later is attached to second surface 2b. Second surface 2b is provided with a plurality of holes into which the plurality of terminals 6 to be described later are fitted. Base 2 is provided with the holes corresponding to each terminal 6 at the positions of each terminals 6 shown in FIGS. 1 and 4.

As shown in FIG. 2, base 2 is concentrically divided into a plurality of regions. Base 2 of this example is divided into inside region 20, first outside region 21, and second outside region 22. In FIG. 2, inside region 20, first outside region 21, and second outside region 22 are hatched differently for ease of understanding. Inside region 20 is a circular region centered at the center of base 2. The center of base 2 is the center of a circle formed by the outline of base 2 in a plan view. The diameter of inside region 20 is 80% or less of the diameter of base 2. When the diameter of inside region 20 is 80% or less of the diameter of base 2, it is possible to secure an area in which a plurality of outside heating bodies 5 can be disposed outside of inside heating body 4. The diameter of inside region 20 is 50% or less of the diameter of base 2. The diameter of inside region 20 is 10% or more of the diameter of base 2. When the diameter of inside heating body 4 is 10% or more of the diameter of base 2, it is possible to secure an area in which inside heating body 4 can be disposed at the center of base 2. First outside region 21 is an annular region located outside of inside region 20. Second outside region 22 is an annular region located outside of first outside region 21. The plurality of heating bodies 3 to be described later are disposed corresponding to the plurality of regions.

Examples of the material of base 2 include known ceramics. Examples of the ceramic include aluminum nitride, aluminum oxide, and silicon carbide. Base 2 may be composed of a composite material of the ceramic and a metal. Examples of the metal include aluminum, an aluminum alloy, copper, and a copper alloy. The material of base 2 is ceramics in this example.

### <Cylindrical Member>

As shown in FIG. 1, cylindrical member 7 supports base 2 from second surface 2b. Cylindrical member 7 is attached to second surface 2b so as to surround the plurality of terminals 6 in the plan view of heater 1 from first surface 2a. The shape of cylindrical member 7 is not particularly limited. Cylindrical member 7 in this example is a circular cylindrical member. Cylindrical member 7 is disposed to be concentric with base 2. In this example, base 2 and cylindrical member 7 are connected so that the center of cylindrical cylindrical member 7 and the center of disk-shaped base 2 are coaxial.

Both ends of cylindrical member 7 are provided with outwardly bent flange portions 71. A seal member (not shown) is disposed between flange portion 71 of the upper end portion and second surface 2b. A seal member (not shown) is also disposed between flange portion 71 at the lower end and a portion onto which the heater is installed 9 of heater 1. The interior of cylindrical member 7 is sealed by these sealing members. The chamber in which heater 1 is disposed is typically filled with a corrosive gas. Since the inside of cylindrical member 7 is sealed, each terminal 6 and a lead-out line 65 of each terminal 6 housed inside cylindrical member 7 can be isolated from corrosive gas. Flange portion 71 of the upper end portion and second surface 2b may be directly bonded to each other without a sealing member interposed therebetween.

Similar to the material of base 2, the material of cylindrical member 7 is a known ceramic. The material of cylindrical member 7 and the material of base 2 may be the same or different.

### <Heating Body>

Each of the plurality of heating bodies 3 is a heat source that heats a heating target (not shown) via base 2. The shape of each heating body 3 is not particularly limited. In the plan view of heater 1 from first surface 2a, the shape of the outer peripheral contour line of each heating body 3 is generally circular. The plurality of heating bodies 3 are disposed corresponding to each of the plurality of regions provided in base 2. Each heating body 3 is disposed to be concentric with base 2 and cylindrical member 7. Thus, the plurality of heating bodies 3 are disposed to be concentric. Here, the concentric shape means that in the plan view of heater 1 from first surface 2a, the envelope circles of each heating body 3 have a common center and the diameters of the envelope circles of each heating body 3 are different from each other. The center of this envelope circle coincides with the center of base 2. In the present specification, the center side means the center side of the envelope circle, and the outside means the portion away from the center in the radial direction of the envelope circle.

As shown in FIGS. 1 and 4, the plurality of heating bodies 3 include one inside heating body 4 and the plurality of outside heating bodies 5. The diameter of the envelope circle of each outside heating body 5 is larger than the diameter of the envelope circle of inside heating body 4. Most of inside heating body 4 is located in inside region 20 shown in FIG. 2. The plurality of outside heating bodies 5 include first outside heating body 51 and second outside heating body 52. In this example, most of first outside heating body 51 is disposed in first outside region 21 shown in FIG. 2. In this example, most of second outside heating body 52 is disposed in second outside region 22 shown in FIG. 2. In this example, the diameters of the enveloping circles of the plurality of heating bodies 3 increase in the order of inside heating body 4, first outside heating body 51, and second outside heating body 52. In the plan view of heater 1 from first surface 2a, each heating body 3 may be disposed so as to partially overlap each other in the radial direction of the envelope circles, or may be disposed to be spaced from each other without overlapping. In this example, in the plan view of heater 1 from first surface 2a, each heating body 3 has a portion overlapping with each other. For example, as shown in FIG. 1 and FIG. 4, inside heating body 4 and first outside heating body 51 have a portion overlapping each other. Inside heating body 4 and second outside heating body 52 have a portion overlapping each other. First outside heating body 51 and second outside heating body 52 have a portion overlapping each other.

In the present example, three heating bodies 3 are disposed. In this example, second outside heating body 52 is an outermost outside heating body, and first outside heating body 51 is an intermediate heating body disposed between inside heating body 4 and second outside heating body 52.

Heating bodies 3 are temperature-controlled independently of each other. Since the plurality of heating bodies 3 are disposed to be concentric, the temperature of base 2 is controlled in the radial direction.

As shown in FIGS. 1 and 4, each heating body 3 is disposed in base 2. Heating bodies 3 are disposed to be spaced from each other in layers in the thickness direction of base 2. Inside heating body 4 is disposed at the first layer located closest to first surface 2a in the thickness direction of base 2. Since inside heating body 4 is disposed at the first layer, it is possible to secure a long length between inside heating body 4 and second surface 2b. Further, since inside heating body 4 is disposed at the first layer, inside heating body 4 is hardly affected by the position of terminal 6 connected to outside heating body 5 as compared with the case where inside heating body 4 is disposed at a layer other than the first layer, and it is easy to dispose inside heating body 4 in base 2.

First outside heating body 51 and second outside heating body 52 are in a specific positional relationship in the thickness direction of base 2. First outside heating body 51 is disposed at the second layer adjacent to the first layer in the thickness direction of base 2. Second outside heating body 52 is disposed at the third layer located closer than the second layer to second surface 2b in the thickness direction of base 2. Second outside heating body 52 is disposed at a position more distant from inside heating body 4 than first outside heating body 51.

The distance between the adjacent layers in which each heating body 3 is disposed is 1 mm to 15 mm. The distance refers to a distance between the first layer and the second layer or a distance between the second layer and the third layer. The distance between the first layer and the second layer is an interlayer distance D2 shown in FIG. 4. Interlayer distance D2 is a length between a surface closer to second surface 4b of inside heating body 4 and a surface closer to first surface 51a of first outside heating body 51. The distance between the second layer and the third layer is a length obtained by subtracting interlayer distance D2 and the thickness of first outside heating body 51 from an interlayer distance D1 shown in FIG. 4. Interlayer distance D1 is the length between surface closer to second surface 4b of inside heating body 4 and a surface closer to first surface 52a of second outside heating body 52. When the distance is 1 mm or more, the plurality of heating bodies 3 can be easily formed in a layer shape in base 2 to be spaced from each other in the thickness direction of base 2. A method of manufacturing each heating body 3 will be described later. When the distance is 15 mm or less, base 2 including heating bodies 3 can be prevented from being excessively thick. When the interval 15 mm or less, it is possible to prevent a difference in distance from each heating body 3 to first surface 2a from becoming excessive, and it is easy to perform temperature control of first surface 2a. The distance is 2 mm to 10 mm, particularly 3 mm to 8 mm. The thickness of base 2 is generally 10 mm to 30 mm.

Each heating body 3 is formed by bending a belt-like portion. The belt-like portion is bent in a spiral shape or a meandering shape. The width of the belt-like portion may be uniform in the longitudinal direction of the belt-like portion, or may be different depending on the position in the longitudinal direction of the belt-like portion. The width of the belt-like portion is a dimension in a direction orthogonal to the longitudinal direction of the belt-like portion in the plan view of heater 1 from first surface 2a. The widths of the belt-like portions is 0.1 mm to 10 mm, further 0.5 mm to 8 mm, particularly 1 mm to 5 mm. Each heating body 3 may include a planar portion having a predetermined shape that is wider than the belt-like portion. The planar portion is disposed so as to be continuously connected to the belt-like portion. Examples of the shape of the planar portion include a fan shape and a semicircular shape. The belt-like portion and the planar portion are preferably foil-shaped bodies. The circuit pattern of each heating body 3 is not particularly limited. The circuit pattern of each heating body 3 can be appropriately selected in accordance with the heating temperature and the required temperature distribution.

In the case where each heating body 3 is a foil-shaped body, the average thickness of each heating body 3 is 1 μm to 500 μm. When the average thickness of each heating body 3 is 1μm or more, heating body 3 can be easily formed in base 2. When the average thickness of each heating body 3 is 500 μm or less, a heating target (not shown) is easily heated well. When the average thickness of each heating body 3 is 500 μm or less, terminal 6 described later easily penetrates through heating body 3. For example, as shown in FIG. 4, second terminal 62 penetrates through second outside heating body 52. Even in this case, heater 1 of this example can prevent terminal 6 penetrating heating body 3 from interfering with inside heating body 4 as will be described later. The average thickness of each heating body 3 is further 5 μm to 100 μm, particularly 10 μm to 50 μm. When the average thickness of each heating body 3 is 5 μm or more, the electrical connection with each terminal 6 is easily secured. When the average thickness of each heating body 3 is 10 μm or more, it is easy to ensure the mechanical strength of each heating body 3. The average thickness of each heating body 3 is an average value of thicknesses measured at three or more measurement points in the longitudinal direction of heating body 3.

As shown in FIGS. 5 and 6, in the plan view of heater 1 from first surface 2a, inside heating body 4 is located outside of the inscribed circle formed by third terminal 63. That is, an outer peripheral contour line 4c of inside heating body 4 is located outside of the inscribed circle formed by third terminal 63. In particular, outer peripheral contour line 4c of inside heating body 4 is located outside of an inner peripheral contour line 7c of cylindrical member 7. Cylindrical member 7 shown in FIGS. 5 and 6 is a portion other than flange portion 71. Outer peripheral contour line 4c of the present example is located outside of inner peripheral contour line 7c. Outer peripheral contour line 4c may be located inside of inner peripheral contour line 7c and outside of the inscribed circle formed by third terminal 63.

In inside heating body 4 of the present example, a sufficient circuit pattern is set on the center side of base 2 as will be described later. Therefore, inside heating body 4 of the present example can sufficiently heat the center of base 2.

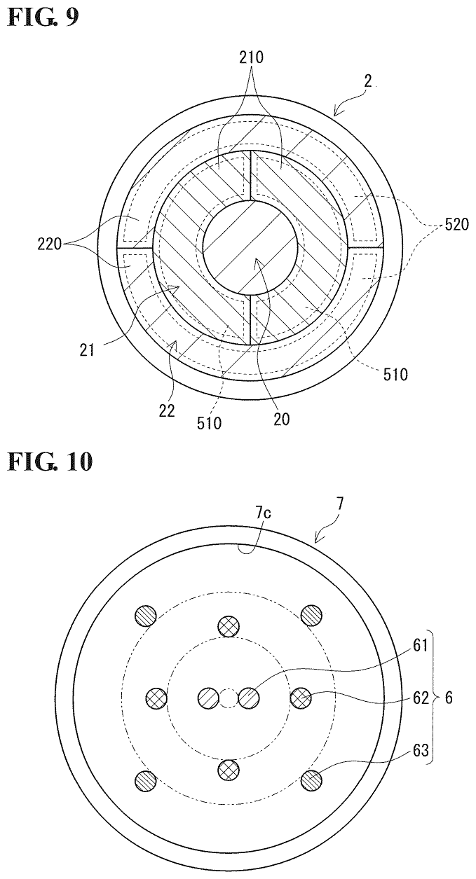

At least one of the plurality of outside heating bodies 5 is formed by a plurality of heating body segments divided in a circumferential direction. In this example, as shown in FIG. 2, first outside region 21 provided in base 2 includes a plurality of divided regions 210 divided in the circumferential direction. First outside heating body 51 of the present example is formed by a plurality of heating body segments 510 divided in the circumferential direction correspond to the plurality of divided regions 210. In FIG. 2, the outline of each heating body segment 510 is virtually indicated by a dashed line. The same applies to FIGS. 9 and 11. In this example, the number of the plurality of heating body segments 510 is three. The number of the plurality of heating body segments 510 may be two as in modification 1 to be described later, four as in modification 2, or five or more. Since first outside heating body 51 is formed by the plurality of heating body segments 510, the temperature of base 2 is independently controlled for each divided region 210. First outside heating body 51 may be constituted by one annular member that is not divided.

In this example, as shown in FIG. 2, second outside region 22 provided in base 2 includes a plurality of divided regions 220 divided in the circumferential direction. Second outside heating body 52 of the present example is formed by a plurality of heating body segments 520 divided in the circumferential direction corresponding to the plurality of divided regions 220. In FIG. 2, the outline of each heating body segment 520 is virtually indicated by a dashed line. The same applies to FIGS. 9 and 11. In this example, the number of the plurality of heating body segments 520 is three. The number of the plurality of heating body segments 520 may be two as in modification 1 to be described later, four as in modification 2, or five or more. Since second outside heating body 52 is formed by the plurality of heating body segments 520, the temperature of base 2 is independently controlled for each divided region 220. Second outside heating body 52 may be formed by one annular member that is not divided.

Since both of first outside heating body 51 and second outside heating body 52 is formed by a plurality of heating body segments, the temperature of base 2 is controlled in the circumferential direction in addition to the temperature control in the radial direction of base 2.

As shown in FIG. 4, a connection portion of each heating body 3 with terminal 6 to be described later is drawn to the center side of base 2. The connection point between inside heating body 4 and terminal 6 is located substantially at the center of base 2. First outside heating body 51 includes a lead-in portion 511 extending toward the center of base 2. Terminal 6 is connected to lead-in portion 511. Second outside heating body 52 includes a lead-in portion 521 extending toward the center of base 2. Terminal 6 is connected to lead-in portion 521. Each lead-in portions 511, 521 extends to the location of terminal 6 to which it is connected.

The material of each heating body 3 is not particularly limited as long as it can heat the heating target to a desired temperature. Examples of the material of each heating body 3 include known metals suitable for resistance heating. Examples of the metal include one selected from the group consisting of stainless steel, nickel, a nickel alloy, silver, a silver alloy, tungsten, a tungsten alloy, molybdenum, a molybdenum alloy, chromium, and a chromium alloy. Examples of the nickel alloy include nichrome.

Each heating body 3 can be manufactured, for example, by a combination of a screen printing method and a hot press bonding method. In the case of this example, it can be manufactured by the following procedure. Four ceramic substrates and a screen mask to which each heating body 3 can be transferred are prepared. As the screen mask, a mask capable of forming circuit patterns of inside heating body 4, first outside heating body 51, and second outside heating body 52 is used. A screen mask having a circuit pattern to be produced is placed on each of the three ceramic substrates. Paste to be heating body 3 is applied to a ceramic substrate on which a screen mask is placed. A squeegee is used to transfer heating body 3 to the ceramic substrate. After transfer of heating body 3, the screen mask is removed. As described above, the first substrate to which inside heating body 4 is transferred, the second substrate to which first outside heating body 51 is transferred, and the third substrate to which second outside heating body 52 is transferred are obtained. The first substrate, the second substrate, the third substrate, and the ceramic substrate to which the heating body is not transferred are stacked in order and bonded by hot pressing. By this bonding, each heating body 3 is disposed in base 2.

The form of each heating body 3 is not particularly limited. For example, as described above, it may be formed by screen printing and firing a paste containing metal powder such as tungsten. Silver paste and silver plus palladium paste may be used for screen printing. In addition, a patterned metal foil such as a stainless steel foil may be used. Further, a tungsten coil or a molybdenum coil can be used as each heating body 3.

### <Terminal>

Each of the plurality of terminals 6 supplies electric power to each heating body 3 connected thereto. The plurality of terminals 6 are provided corresponding to the plurality of heating bodies 3. The plurality of terminals 6 in this example include first terminal 61, second terminal 62, and third terminal 63. As shown in FIG. 3, first terminal 61, second terminal 62, and third terminal 63 are concentrically disposed in order from the center side. The plurality of terminals 6 being concentrically disposed means that a group of terminals 6 connected to each heating body 3 disposed at each layer are disposed so as to overlap on a circumference concentric with an envelope circle of each heating body 3. Each of the group of terminals of first terminal 61, the group of terminals of second terminal 62, and the group of terminals of third terminal 63 may have at least a portion overlapping on the circumference concentric with the envelope circle, and the center of each group of terminals 6 may be shifted from the circumference. In this example, the centers of each group of terminals 6 are located on the circumference.

First terminal 61 is located approximately at the center of base 2, as shown in FIG. 4. First terminal 61 is connected to inside heating body 4. Second terminal 62 is connected to second outside heating body 52. Second outside heating body 52 is a heating body disposed at the third layer located closer than the second layer adjacent to the first layer to second surface 2b in the thickness direction of base 2. Third terminal 63 is connected to first outside heating body 51. First outside heating body 51 is a heating body disposed at the second layer adjacent to the first layer in the thickness direction of base 2.

The plurality of terminals 6 are provided corresponding to the number of each heating body 3. The number of terminals 6 is usually an even number. Inside heating body 4 of the present example is not divided and is configured as one body. Therefore, the number of first terminals 61 is two at each end of the belt-like portion. Second outside heating body 52 of the present example is formed by three heating body segments. Therefore, the number of second terminals 62 is six. Six second terminals 62 are disposed at equal intervals on the circumference. Each second terminal 62 is connected to lead-in portion 521 of second outside heating body 52. First outside heating body 51 of the present example is formed by three heating body segments. Therefore, the number of third terminals 63 is six. Six third terminals 63 are disposed at equal intervals on the circumference. Each third terminal 63 is connected to lead-in portion 511 of first outside heating body 51.

As shown in FIG. 3, the plurality of terminals 6 is located inside of cylindrical member 7 in the plan view of heater 1 from first surface 2a. The plurality of terminals 6 are densely disposed on the center of base 2. As shown in FIG. 1, each terminal 6 in this example extends from second surface 2b of base 2 to the inside of cylindrical member 7. Each terminal 6 is connected to an external power supply (not shown) via lead-out line 65 shown in FIG. 1. The material of each terminal 6 is the same as the material of heating body 3. Lead-out line 65 is made of a conductive material.

As shown in FIG. 4, each terminal 6 of the present example penetrates each heating body 3. Each terminal 6 of the present example includes a tip portion protruding from the surface closer to the first surface of connected heating body 3 towards first surface 2a. First terminal 61 includes a tip portion 610 protruding from the surface closer to the first surface of inside heating body 4 toward first surface 2a. Tip portion 610 does not reach first surface 2a.

Second terminal 62 includes a tip portion 620 protruding from surface closer to first surface 52a of second outside heating body 52 toward first surface 2a. A length L2 of the protruding direction of tip portion 620 is smaller than interlayer distance D1 between inside heating body 4 and second outside heating body 52. Interlayer distance D1 is 1 mm to 15 mm, further 2 mm to 10 mm, particularly 3 mm to 8 mm. Tip portion 620 does not interfere with inside heating body 4. There is a relatively large distance between tip portion 620 and inside heating body 4.

Third terminal 63 includes a tip portion 630 protruding from the surface closer to the first surface of first outside heating body 51 toward first surface 2a. Tip portion 630 is close to but does not interfere with inside heating body 4. As shown in FIGS. 1 and 4, inside heating body 4 is not disposed directly above tip portion 630. Tip portion 630 is located outside of tip portion 620 in the radial direction of base 2. Therefore, the space between adjacent third terminals 63 has a margin as compared with the space between adjacent second terminals 62. Therefore, third terminal 63 can be easily disposed so as not to overlap inside heating body 4 in the plan view of heater 1 is from first surface 2a.

The shape of each terminal 6 in the present example is a truncated cone shape that is tapered on the tip side. Since the shape of each terminal 6 is a truncated cone shape, the contact area between each terminal 6 and each heating body 3 is easily secured compared to a cylindrical terminal having a uniform outer diameter. The tapered portion of the truncated cone shape of each terminal 6 is in contact with each heating body 3. A part of the truncated cone shape in second terminal 62 is tip portion 620.

The tip end of each terminal 6 may be formed in a screw shape. In this case, a screw hole corresponding to the screw shape is formed in base 2 at a position where each terminal 6 is disposed. The screw shape of each terminal 6 and the screw hole of base 2 are fitted to each other, and each terminal 6 is fixed to base 2.

### <Action and Effect>

As shown in FIG. 4, heater 1 of the first embodiment can prevent second terminal 62 from interfering with inside heating body 4. This is because second terminal 62 is connected to second outside heating body 52, interlayer distance D1 shown in FIG. 4 can be ensured to be larger than that in the case where second terminal 62 is connected to first outside heating body 51. Since second terminal 62 does not interfere with inside heating body 4, inside heating body 4 can be disposed at a desired position without considering the position of second terminal 62. For example, as shown in FIG. 5, in the plan view of heater 1 from first surface 2a, inside heating body 4 can be disposed so as to overlap second terminal 62. Alternatively, as shown in FIG. 6, inside heating body 4 can be disposed between first terminal 61 and second terminal 62 and between second terminal 62 and third terminal 63. In the plan view of heater 1 from first surface 2a, inside heating body 4 is preferably disposed so as to avoid third terminal 63. This is because third terminal 63 is close to inside heating body 4 as shown in FIG. 4. This is because interlayer distance D2 between inside heating body 4 and first outside heating body 51 is smaller than interlayer distance D1 between inside heating body 4 and second outside heating body 52.

As a comparative example, FIG. 7 shows a configuration in which second terminal 62 is connected to first outside heating body 51 and third terminal 63 is connected to second outside heating body 52. In the heater of this form, as shown in FIG. 8, in the plan view of heater 1 from first surface 2a, inside heating body 4 cannot be disposed so as to overlap second terminal 62, and inside heating body 4 cannot be sufficiently disposed on the center side of base 2. This is because second terminal 62 is close to inside heating body 4 as shown in FIG. 7. This is because interlayer distance D2 between inside heating body 4 and first outside heating body 51 is smaller than interlayer distance D1 between inside heating body 4 and second outside heating body 52.

The present invention is not limited to these examples, but is defined by the scope of the claims, and is intended to include all modifications within the meaning and scope equivalent to the scope of the claims. For example, the following modifications are possible in the above-described embodiment.

### <Modification 1>

As shown in FIG. 9, first outside region 21 provided in base 2 may be composed of two divided regions 210. That is, the number of the plurality of heating body segments 510 constituting first outside heating body 51 (FIGS. 1 and 4) may be two. In this case, the number of third terminals 63 connected to first outside heating body 51 (FIGS. 1 and 4) is four as shown in FIG. 10. As shown in FIG. 9, second outside region 22 provided in base 2 may be composed of two divided regions 220. That is, the number of the plurality of heating body segments 520 constituting second outside heating body 52 (FIGS. 1 and 4) may be two. In this case, the number of second terminals 62 connected to second outside heating body 52 (FIGS. 1 and 4) is four as shown in FIG. 10. Even in the case of modification 1, it is possible to prevent second terminal 62 from interfering with inside heating body 4 and to sufficiently dispose inside heating body 4 on the center side of base 2.

### <Modification 2>

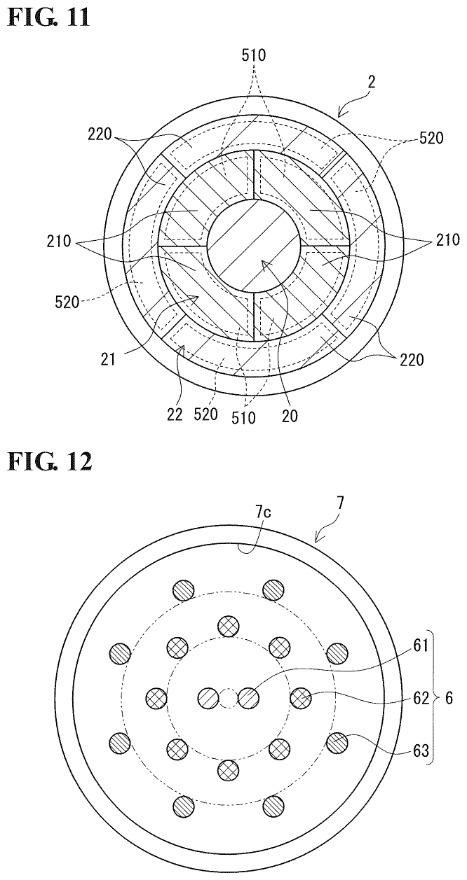

As shown in FIG. 11, first outside region 21 provided in base 2 may be composed of four divided regions 210. That is, the number of the plurality of heating body segments 510 constituting first outside heating body 51 (FIGS. 1 and 4) may be four. In this case, the number of third terminals 63 connected to first outside heating body 51 (FIGS. 1 and 4) is eight as shown in FIG. 12. As shown in FIG. 11, second outside region 22 provided in base 2 may be composed of four divided regions 220. That is, the number of the plurality of heating body segments 520 constituting second outside heating body 52 (FIGS. 1 and 4) may be four. In this case, the number of second terminals 62 connected to second outside heating body 52 (FIGS. 1 and 4) is eight as shown in FIG. 12. Even in the case of modification 2, it is possible to prevent second terminal 62 from interfering with inside heating body 4 and to sufficiently dispose inside heating body 4 on the center side of base 2.

### <Modification 3>

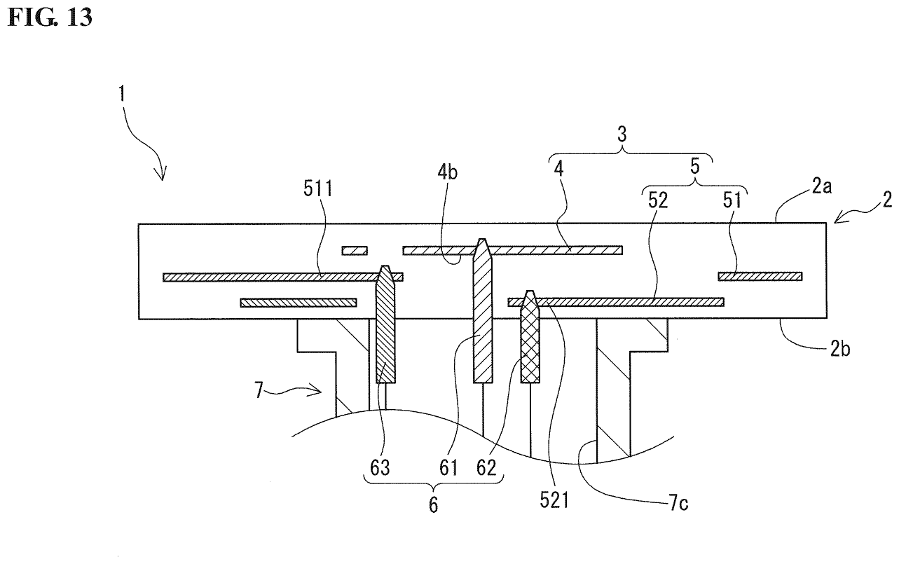

As the positional relationship of the plurality of outside heating bodies 5 in the radial direction of base 2, as shown in FIG. 13, first outside heating body 51 may be disposed in second outside region 22 shown in FIG. 2, and second outside heating body 52 may be disposed in first outside region 21 shown in FIG. 2. In the present example, the outer diameter of first outside heating body 51 is larger than the outer diameter of second outside heating body 52. Even in this case, second terminal 62 is connected to second outside heating body 52 disposed at the third layer. Third terminal 63 is connected to first outside heating body 51 disposed at the second layer. Even in the case of modification 3, it is possible to prevent second terminal 62 from interfering with inside heating body 4 and to sufficiently dispose inside heating body 4 on the center side of base 2.

### <Modification 4>

Three or more outside heating bodies may be provided on the outside of the inside heating body. Also in this case, the second terminal is connected to the second outside heating body disposed at a layer subsequent to the third layer located closer than the second layer to the second surface in the thickness direction of base 2. In other words, the second terminal is connected to an outside heating body other than the first outside heating body disposed at the second layer. The second terminal may be connected to any outside heating body other than the first outside heating body.

### REFERENCE SIGNS LIST

1 heater
2 base
2a first surface, 2b second surface
20 inside region, 21 first outside region, 210 divided region
22 second outside region, 220 divided region
D1, D2 interlayer distance
3 heating body
4 inside heating body
4b surface closer to second surface, 4c outer peripheral contour line
5 outside heating body
51 first outside heating body, 510 heating body segment
51a surface closer to first surface
511 lead-in portion
52 second outside heating body, 520 heating body segment
52a surface closer to first surface
521 lead-in portion
6 terminal
61 first terminal, 62 second terminal, 63 third terminal, 610, 620, 630 tip portion 65 lead-out line
L2 length
7 cylindrical member
71 flange portion, 7c inner peripheral contour line
9 portion onto which heater is installed

1. A heater comprising:
a disk-shaped base;
a plurality of heating bodies disposed in the base;
a plurality of terminals each connected to a corresponding one of the plurality of heating bodies; and
a cylindrical member attached to the base,
wherein the base has
a first surface on which a heating target is placed, and
a second surface opposite to the first surface,
wherein the plurality of heating bodies include
an inside heating body disposed in a region including a center of the base, and
a plurality of outside heating bodies disposed outside of the inside heating body to be concentric with the base,
wherein the inside heating body and the plurality of outside heating bodies are disposed to be spaced from each other in a thickness direction of the base,
wherein the inside heating body is disposed at a first layer located closest to the first surface in the thickness direction of the base,
wherein the plurality of outside heating bodies include
a first outside heating body disposed at a second layer adjacent to the first layer in the thickness direction of the base, and
a second outside heating body disposed at a third layer located closer than the second layer to the second surface in the thickness direction of the base,
wherein the plurality of terminals include a first terminal, a second terminal, and a third terminal concentrically disposed in order from a center side of the base,
wherein the first terminal is connected to the inside heating body,
wherein the second terminal is connected to the second outside heating body, and
wherein the cylindrical member is attached to the second surface to surround the plurality of terminals in a plan view of the heater from the first surface.

2. The heater according to claim 1, wherein, in the plan view of the heater from the first surface, an outer peripheral contour line of the inside heating body is located outside of an inscribed circle centered at the center of the base and formed by the third terminal.

3. The heater according to claim 1, wherein, in the plan view of the heater from the first surface, an outer peripheral contour line of the inside heating body is located outside of an inner peripheral contour line of the cylindrical member.

4. The heater according to claim 1, wherein at least one of the plurality of outside heating bodies is formed by a plurality of heating body segments divided in a circumferential direction.

5. The heater according to claim 1,
wherein the second terminal includes a tip portion protruding from a surface of the second outside heating body closer to the first surface toward the first surface,
wherein a length of the tip portion in a protruding direction of the tip portion is smaller than an interlayer distance, and
wherein the interlayer distance is a length between the surface of the second outside heating body closer to the first surface and a surface of the inside heating body closer to the second surface.

6. The heater according to claim 5, wherein the interlayer distance is 1 mm to 15 mm.

7. The heater according to claim 1,
wherein each of the plurality of heating bodies is a foil-shaped body, and
wherein an average thickness of each of the plurality of heating bodies is 1 μm to 500 μm.

8. (canceled)

9. The heater according to claim 2, wherein, in the plan view of the heater from the first surface, an outer peripheral contour line of the inside heating body is located outside of an inner peripheral contour line of the cylindrical member.

10. The heater according to claim 2, wherein at least one of the plurality of outside heating bodies is formed by a plurality of heating body segments divided in a circumferential direction.

11. The heater according to claim 3, wherein at least one of the plurality of outside heating bodies is formed by a plurality of heating body segments divided in a circumferential direction.

12. The heater according to claim 2,
wherein the second terminal includes a tip portion protruding from a surface of the second outside heating body closer to the first surface toward the first surface,
wherein a length of the tip portion in a protruding direction of the tip portion is smaller than an interlayer distance, and
wherein the interlayer distance is a length between the surface of the second outside heating body closer to the first surface and a surface of the inside heating body closer to the second surface.

13. The heater according to claim 3,
wherein the second terminal includes a tip portion protruding from a surface of the second outside heating body closer to the first surface toward the first surface,
wherein a length of the tip portion in a protruding direction of the tip portion is smaller than an interlayer distance, and
wherein the interlayer distance is a length between the surface of the second outside heating body closer to the first surface and a surface of the inside heating body closer to the second surface.

14. The heater according to claim 4,
wherein the second terminal includes a tip portion protruding from a surface of the second outside heating body closer to the first surface toward the first surface,
wherein a length of the tip portion in a protruding direction of the tip portion is smaller than an interlayer distance, and
wherein the interlayer distance is a length between the surface of the second outside heating body closer to the first surface and a surface of the inside heating body closer to the second surface.

15. The heater according to claim 2,
wherein each of the plurality of heating bodies is a foil-shaped body, and
wherein an average thickness of each of the plurality of heating bodies is 1 μm to 500 μm.

16. The heater according to claim 3,
wherein each of the plurality of heating bodies is a foil-shaped body, and
wherein an average thickness of each of the plurality of heating bodies is 1 μm to 500 μm.

17. The heater according to claim 4,
wherein each of the plurality of heating bodies is a foil-shaped body, and
wherein an average thickness of each of the plurality of heating bodies is 1 μm to 500 μm.

18. The heater according to claim 5,
wherein each of the plurality of heating bodies is a foil-shaped body, and
wherein an average thickness of each of the plurality of heating bodies is 1 μm to 500 μM.

19. The heater according to claim 6,
wherein each of the plurality of heating bodies is a foil-shaped body, and
wherein an average thickness of each of the plurality of heating bodies is 1 μm to 500 μm.

20. A heater comprising:
a disk-shaped base;
a plurality of heating bodies disposed in the base;
a plurality of terminals each connected to a corresponding one of the plurality of heating bodies; and
a cylindrical member attached to the base,
wherein the base has
a first surface on which a heating target is placed, and
a second surface opposite to the first surface,
wherein the plurality of heating bodies include
an inside heating body disposed in a region including a center of the base,
an outside heating body disposed outside of the inside heating body to be concentric with the base, and
an intermediate heating body disposed between the inside heating body and the outside heating body,
wherein the inside heating body, the outside heating body, and the intermediate heating body are disposed to be spaced from each other in a thickness direction of the base,
wherein the inside heating body is disposed at a first layer located closest to the first surface in the thickness direction of the base,
wherein the outside heating body is disposed at a third layer located closest to the second surface in the thickness direction of the base,
wherein the intermediate heating body is disposed at a second layer located between the first layer and the third layer,
wherein the plurality of terminals include a first terminal, a second terminal, and a third terminal disposed concentrically in order from a center side of the base,
wherein the first terminal is connected to the inside heating body,
wherein the second terminal is connected to the outside heating body,
wherein the third terminal is connected to the intermediate heating body, and
wherein the cylindrical member is attached to the second surface to surround the plurality of terminals in a plan view of the heater from the first surface.
